(19) United States
(12) Patent Application Publication
(10) Pub. No.: US 2011/0042492 A1
(43) Pub. Date: Feb. 24, 2011

(54) NOZZLE ASSEMBLY

(76) Inventor: Chin-Chi Pan, Ho Me Chen (TW)

Correspondence Address: The Weintraub Group, P.L.C., 28580 Orchard Lake Road, Suite 140, Farmington Hills, MI, 48334, US

(21) Appl. No.: 12/626,824

(22) Filed: Nov. 27, 2009

(30) Foreign Application Priority Data
Aug. 21, 2009 (TW) 098215478

(51) Int. Cl. B05B 1/00

(52) U.S. Cl. 239/589

(57) ABSTRACT

A nozzle assembly has a housing, a joint, a spraying head assembly, a connector and a switch assembly. The housing is tubular and has an inside space. The joint is mounted in the inside space of the housing and has a front end and a rear end. The spraying head assembly is mounted securely on the front end of the joint. The connector is mounted securely on the rear end of the joint. The switch assembly is mounted in the inside space of the housing and has a button. The switch assembly is switched by the button. With the button, the volume of the nozzle assembly becomes small. This can be easily held by hands and is very handy and convenient in use.

### BACKGROUND OF THE INVENTION

1. Field of the Invention

The present invention relates to a nozzle assembly, and more particularly to a nozzle assembly that is switched by pressing a button.

2. Description of Related Art

A conventional nozzle assembly comprises a handle and a lever switch. The handle has a front end and a rear end. The rear end of the handle is connected with a fountain. The lever switch is pivotally connected with the handle. When the lever switch is pressed, water will flow from the rear end to the front end of the handle and is sprayed out. When the lever switched is released, water will be stopped.

However, the lever switch is too long to allow children or people with small hands to hold. Additionally, to allow the lever switch to rise, the conventional nozzle assembly is bulky.

To overcome the shortcomings, the present invention tends to provide a nozzle assembly to obviate the aforementioned problems.

### SUMMARY OF THE INVENTION

The main objective of the invention is to provide a nozzle assembly that is switched by pressing a button and is small, handy and convenient.

A nozzle assembly has a housing, a joint, a spraying head assembly, a connector and a switch assembly. The housing is tubular and has an inside space. The joint is mounted in the inside space of the housing and has a front end and a rear end. The spraying head assembly is mounted securely on the front end of the joint. The connector is mounted securely on the rear end of the joint. The switch assembly is mounted in the inside space of the housing and has a button. The switch assembly is switched by the button. With the button, the volume of the nozzle assembly becomes small. This can be easily held by hands and is very handy and convenient in use.

Other objects, advantages and novel features of the invention will become more apparent from the following detailed description when taken in conjunction with the accompanying drawings.

### BRIEF DESCRIPTION OF THE DRAWINGS

FIG. 1 is a perspective view of a nozzle assembly in accordance with the present invention;

FIG. 2 is an exploded perspective view of the nozzle assembly in FIG. 1;

FIG. 3 is an enlarged exploded perspective view of the switch assembly in FIG. 2.

FIG. 4 is a cross sectional side view of the nozzle assembly in FIG. 1,

FIG. 5 is an enlarged operational side view of the nozzle assembly in FIG. 4, wherein the button is pressed down; and

FIG. 6 is an operational side view of the nozzle assembly in FIG. 5, wherein the denticles of the second disc are held in the denticle recesses of the sleeve.

### DETAILED DESCRIPTION OF PREFERRED EMBODIMENT

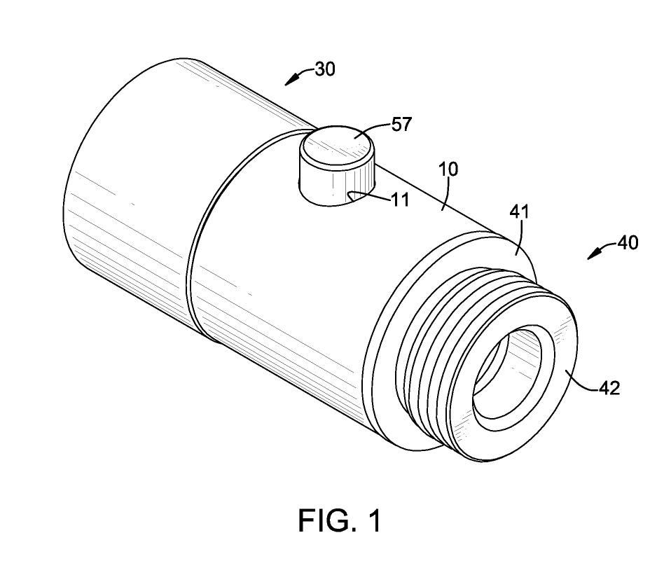

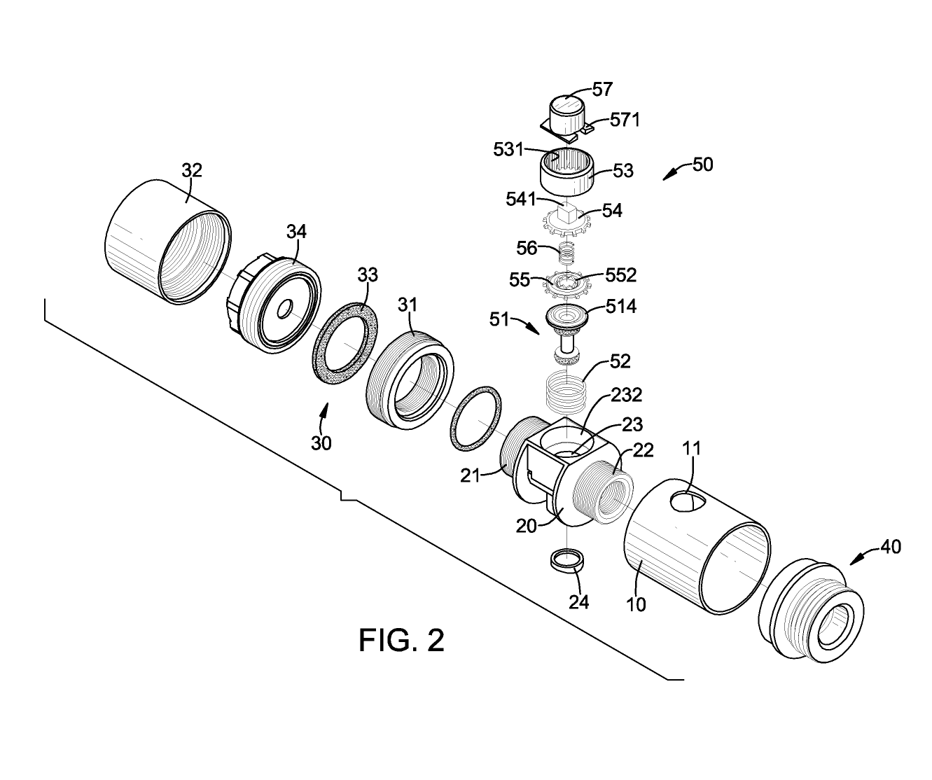

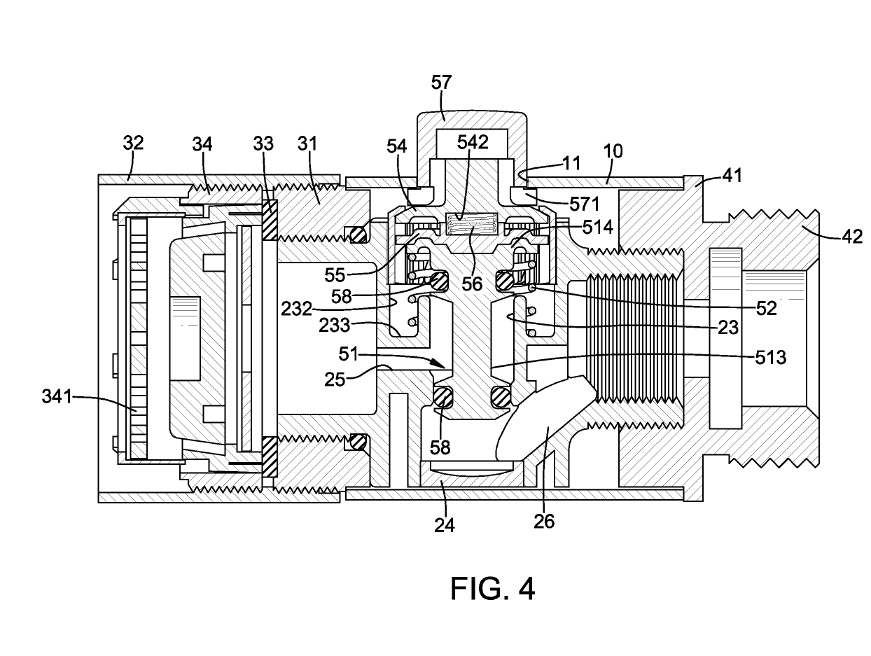

With reference to FIGS. 1, 2 and 4, a nozzle assembly comprises a housing (10), a joint (20), a spraying head assembly (30), a connector (40) and a switch assembly (50).

The housing (10) is tubular and has an inside space, an outer surface, an inner surface, a front end, a rear end and a button hole (11). The button hole (11) is radially defined in the outer surface of the housing (10) and communicates with the inside space of the housing (10).

The joint (20) is tubular, is mounted in the inside space of the housing (10) and has an outer surface, a front threaded end (21), a rear threaded end (22), a pillar hole (23), a plug (24), an outlet (25) and an inlet (26).

The front threaded end (21) is near the front end of the housing (10).

The rear threaded end (22) is near the rear end of the housing (10).

The pillar hole (23) is defined through the outer surface of the joint (20), aligns with the button hole (11) and has an inner surface, a top end, a bottom end, a minimal diameter and a chamber (232). The chamber (232) is defined in the top end of the pillar hole (23) and has an internal diameter and a bottom (233). The internal diameter of the chamber (232) is larger than the minimal diameter of the pillar hole (23).

The plug (24) is mounted securely in the bottom end of the pillar hole (23).

The outlet (25) is defined in the joint (20) near the front threaded end (21) and communicates with the pillar hole (23). The inlet (26) is defined in the joint (20) near the rear threaded end (22) and communicates with the pillar hole (23).

The spraying head assembly (30) is securely mounted around the front threaded end (21) and has a collar (31), a front tube (32), a washer (33) and a spraying device (34). The collar (31) is securely mounted around the outer surface at the front threaded end (21) of the joint (20), abuts the front end of the housing (10) and has an outer surface and a front end. The front tube (32) is securely mounted around the outer surface at the front end of the collar (31) and has an inside space. The washer (33) is mounted in the inside space of the front tube (32), abuts the front end of the collar (31) and has a front side. The spraying device (34) is mounted in the inside space of the front tube (32), abuts the front side of the washer (33) and has a front end and a filter (341). The filter (341) is formed at the front end of the spraying device (34).

The connector (40) is tubular, is securely mounted around the outer surface at the rear threaded end (22) of the joint (20) and has an outer surface, a rear end, a flange (41) and a tube section (42). The flange (41) is formed around and radially protrudes from the outer surface of the connector (40) and abuts the rear end of the housing (10). The tube section (42) is formed on the rear end of the connector (40).

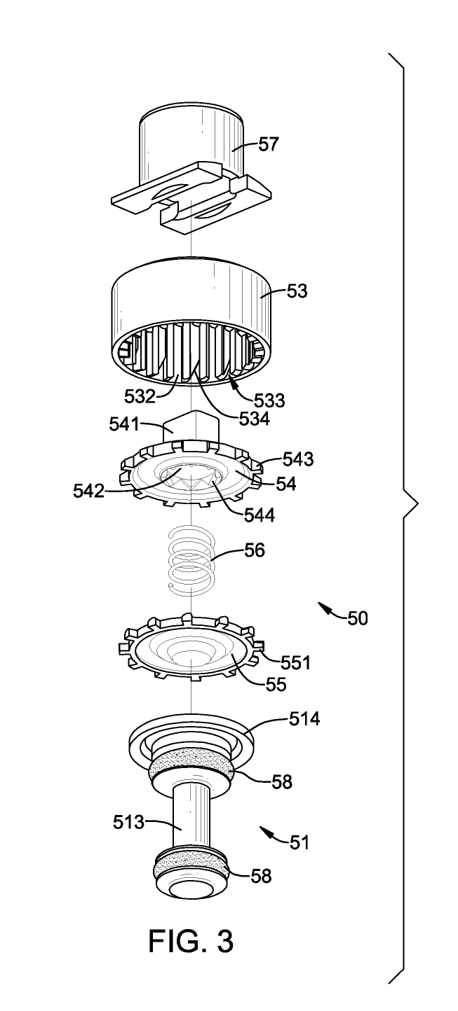

Wither further reference to FIG. 3, the switch assembly (50) is mounted in the pillar hole (23), protrudes from the button hole (11) and has a pillar (51), a pillar spring (52), a sleeve (53), a first disc (54), a second disc (55), a disc spring (56), a button (57) and two O-rings (58).

The pillar (51) is slidably mounted in the pillar hole (23) and has a top, a central segment, a bottom, a maximal diameter, a neck (513) and a disc section (514). The neck (513) is defined on the central segment of the pillar (51) and has a diameter. The diameter of the neck (513) is smaller than the maximal diameter of pillar (51). The disc section (514) is defined around and radially protrudes from the top of pillar (51) and is mounted in the chamber (232).

The pillar spring (52) is compressibly mounted in the chamber (232) and abuts the bottom (233) of the chamber (232) and the disc section (514).

The sleeve (53) is mounted in the chamber (232) and has a bottom end, an inner surface, a sleeve hole (531), multiple grooves (532), multiple denticle recesses (533) and multiple ramps (534).

The sleeve hole (531) is axially defined through the sleeve (53) and aligns with the button hole (11) and the pillar hole (23).

The grooves (532) are longitudinally and linearly elongated, are defined in the inner surface of the sleeve (53) at intervals and have a number. Each groove (532) has an open end facing the disc section (514) and a length.

The denticle recesses (533) have a number same as that of the grooves (532) and are longitudinally defined in the inner surface of the sleeve (53) beside the grooves (532). Each denticle recess (533) is defined between two adjacent grooves (532) and has an open end, a length and a bottom. The ends of the denticle recesses (533) and the ends of the grooves (532) are at a horizontal level. The length of each denticle recess (533) is smaller than that of each groove (532).

The ramps (534) are respectively defined on the bottoms of the denticle recesses (533).

The first disc (54) is slidably mounted in the sleeve (53) and has a top, a bottom, an outer surface, an inner surface, a rod (541), a spring recess (542), multiple denticles (543), multiple ratchets (544) and multiple ratchet recesses.

The rod (541) has a rectangular cross section, axially protrudes from the top of the first disc (54) and protrudes out of the button hole (11).

The spring recess (542) is axially defined in the bottom of the first disc (54).

The denticles (543) radially protrude from the outer surface of the first disc (54) and are respectively inserted slidably into the grooves (532).

The ratchets (544) are formed inwardly on the inner surface of the first disc (54) and each ratchet (544) has a tip and two inclines. The tips of the ratchets (544) face the disc section (514).

The ratchet recesses are formed in the inner surface of the first disc (54) at intervals. Each ratchet recess is defined between two adjacent ratchets (544) of the first disc (54) and has a bottom.

The second disc (55) is slidably mounted in the sleeve (53) between the first disc (54) and the pillar (51) and abuts the top of the pillar (51). The second disc (55) has a top, an outer surface, multiple denticles (551) and multiple ratchets (552).

The denticles (551) radially protrude from the outer surface of the second disc (55) and are respectively inserted slidably into the grooves (532).

The ratchets (552) of the second disc (55) protrude from the top of the second disc (55) toward the ratchets (544) of the first disc (54). Each ratchet (552) of the second disc (55) has a tip. Each tip of the ratchet (552) of the second disc (55) abuts the incline of a corresponding ratchet (544) of the first disc (54) and does not abut the bottom of a corresponding ratchet recess of the first disc (54).

The disc spring (56) is compressibly mounted between and abuts the first disc (54) and the second disc (55). One end of the disc spring (56) is held in the spring recess (542) of the first disc (54).

The button (57) is securely mounted around the rod (541), protrudes out of the button hole (11) and has a bottom and a button protrusion (571). The button protrusion (571) is radially defined around the bottom of the button (57) and abuts the inner surface near the button hole (11) of the housing (10) to prevent the button (57) from dropping out of the button hole (11).

The O-rings (58) are respectively and securely mounted around the top and the bottom of the pillar (51) beside the neck (513) and the disc section (514). The O-ring (58) at the bottom of the pillar (51) abuts the inner surface near the bottom end of the pillar hole (23) to keep water from flowing into the outlet (25).

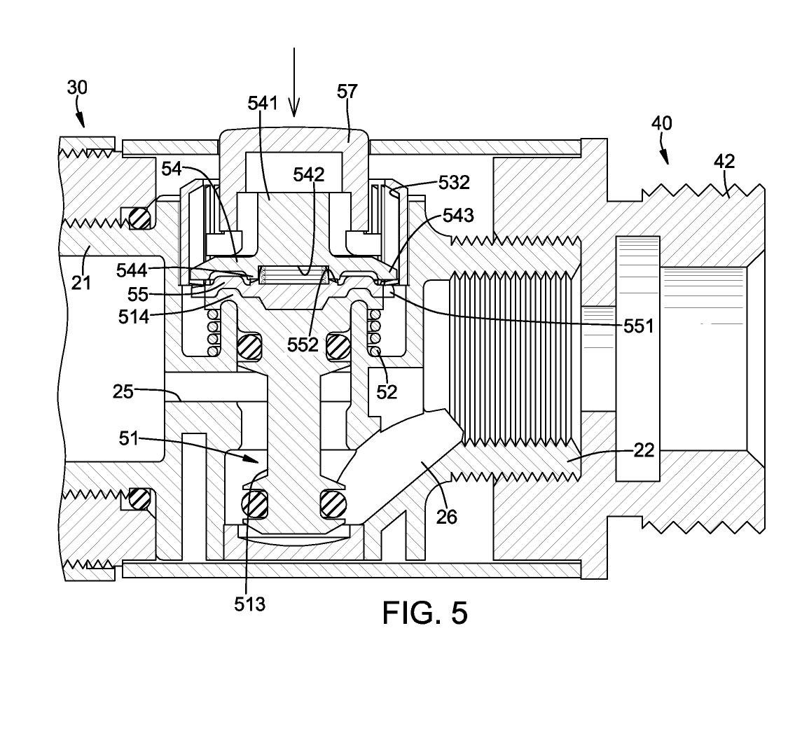

In use, with further reference to FIG. 5, the tube section (42) is connected with a fountain. When the button (57) is pressed down, the first disc (54), the second disc (55) and the disc section (514) will move descendingly. Therefore, water will flow through the inlet (26), the pillar hole (23) and the outlet (25), and is sprayed out from the spraying device (34) through the filter (341).

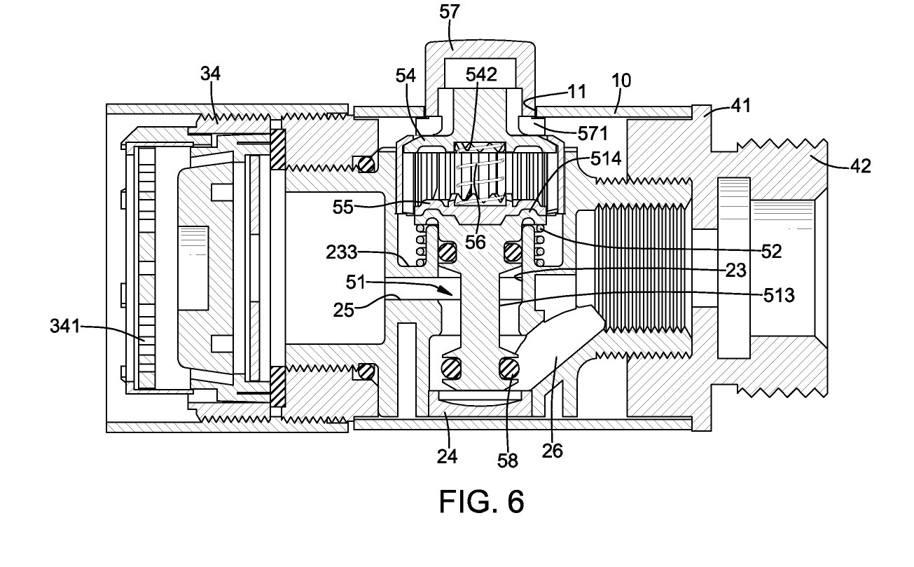

With reference to FIGS. 3 to 5, when the button (57) and the first disc (54) are pressed down, the ratchets (544) of the first disc (54) press the ratchets (552) of the second disc (55) and the denticles (551) of the second disc (55) descend along the grooves (532). When the denticles (551) of the second disc (55) move out of the grooves (532), the tips of ratchets (552) of the second disc (55) slide along the inclines of the ratchets (544) of the first disc (54). Because the inclines of the ratchets (544) of the first disc (54) guide the tips of the ratchets (552) of the second disc (55), the second disc (55) will rotate and the denticles (551) of the second disc (55) will slide along the ramps (534) into the denticle recesses (533) and be held by denticel recesses (533). With further reference to FIG. 6, when the button (57) is released, the disc spring (56) pushes the first disc (54) and the button (57) back into original positions and the second disc (55) still presses the pillar (51) to hold the pillar (51) at a communication position.

To stop the water flow, the button (57) is pressed down again, the ratchets (544) of the first disc (54) press the ratchets (552) of the second disc (55) again to make the denticles (551) of the second disc (55) move out of the denticle recesses (533). Because the inclines of the first disc (54) guide the tips of the second disc (55), the second disc (55) will rotate and the denticles (551) of the second disc (55) will slide into the grooves (532) again. The pillar spring (52) pushes the disc section (514) and the second disc (55) to original positions. Therefore, water flow will be clogged by the O-ring (58) at the bottom of the pillar (51).

From the above description, it is noted that the prevent invention has the following advantages:

1. Small, handy and convenient:

With the button (57), the volume of the nozzle assembly in accordance with the prevent invention becomes small. This can be easily held by hands and is very handy and convenient in use.

2. Effort-saving:

With the arrangements of the ratchets (544, 552) and the grooves (532) and the denticle recesses (533) of the sleeve (53), the denticles (551) of the second disc (55) may slide into the grooves (532) or be held in the denticle recesses (533). Therefore, the pillar (51) can be easily positioned by the second disc (55) to keep water flowing.

Even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A nozzle assembly comprising:
a housing having
an outer surface;
an inside space;
a front end;
a rear end; and
a button hole radially defined in the outer surface of the housing and communicating with the inside space of the housing;
a joint mounted in the inside space of the housing and having
an outer surface;
a front threaded end near the front end of the housing;
a rear threaded end near the rear end of the housing;
a pillar hole defined in the outer surface of the joint, aligning with the button hole and having
a top end;
an inner surface;
a close bottom end;
a minimal diameter;
a chamber defined in the top end of the pillar hole and having a bottom and an internal diameter that is larger than the minimal diameter of the pillar hole;
an outlet defined in the joint near the front threaded end and communicating with the pillar hole; and
an inlet defined in the joint near the rear threaded end and communicating with the pillar hole;
a spraying head assembly securely mounted on the front threaded end and abutting the front end of the housing;
a connector securely mounted on the rear threaded end and abutting the rear end of the housing; and
a switch assembly mounted in the pillar hole and having
a pillar slidably mounted in the pillar hole and having
a top;
a central segment;
a bottom;
a neck defined on the central segment of the pillar; and
a disc section defined around and radially protruding from the top of pillar and mounted in the chamber;
a pillar spring compressibly mounted in the chamber and abutting the bottom of the chamber and the disc section;
a button protruding out of the button hole; and
two O-rings respectively and securely mounted around the top and the bottom of the pillar beside the neck and the disc section.

2. The nozzle assembly as claimed in claim 1, wherein
the spraying head assembly has
a collar securely mounted around the outer surface at the front threaded end of the joint, abutting the front end of the housing and having an outer surface and a front end;
a front tube securely mounted around the outer surface at the front end of the collar and having an inside space;
a washer mounted in the inside space of the front tube, abutting the front end of the collar and having a front side; and
a spraying device mounted in the inside space of the front tube, abutting the front side of the washer and having a front end and a filter formed at the front end of the spraying device.

3. The nozzle assembly as claimed in claim 2, wherein
the connector is tubular and has
an outer surface;
a rear end;
a flange formed around and radially protruding from the outer surface of the connector and abutting the rear end of the housing; and
a tube section formed on the rear end of the connector.

4. The nozzle assembly as claimed in claim 1, wherein
the switch assembly further has
a sleeve mounted in the chamber and having
a bottom end;
an inner surface;
a sleeve hole axially defined through the sleeve and aligning with the button hole and the pillar hole;
multiple grooves longitudinally and linearly elongated, defined in the inner surface of the sleeve at intervals and having a number, each groove having an open end facing the disc section and a length;
multiple denticle recesses having a number same as that of the grooves and longitudinally defined in the inner surface of the sleeve beside the grooves, each denticle recess defined between two adjacent grooves and having
an open end defined on a horizontal level where the ends of the grooves are;
a length smaller than that of each groove; and
a bottom;
multiple ramps respectively defined on the bottoms of the denticle recesses;
a first disc slidably mounted in the sleeve and having
a top;
a bottom;
an outer surface;
an inner surface;
a rod axially protruding from the top of the first disc and protruding out of the button hole;
a spring recess axially defined in the bottom of the first disc;
multiple denticles radially protruding from the outer surface of the first disc and respectively inserted slidably into the grooves; and
multiple ratchets formed inwardly on the inner surface of the first disc, each having two inclines and a tip facing the disc section; and
multiple ratchet recesses formed in the inner surface of the first disc at intervals, each defined between two adjacent ratchets of the first disc and having a bottom;
a second disc slidably mounted in the sleeve between the first disc and the pillar and abutting the top of the pillar and having
a top;
an outer surface;
multiple denticles radially protruding from the outer surface of the second disc and respectively inserted slidably into the grooves; and
multiple ratchets protruding from the top of the second disc toward the ratchets of the first disc, each ratchet having a tip abutting the incline of a corresponding ratchet of the first disc; and
a disc spring compressibly mounted between and abutting the first disc and the second disc and having an end held in the spring recess; and
the button is securely mounted around the rod.

5. The nozzle assembly as claimed in claim 2, wherein
the switch assembly further has
a sleeve mounted in the chamber and having
a bottom end;
an inner surface;
a sleeve hole axially defined through the sleeve and aligning with the button hole and the pillar hole;
multiple grooves longitudinally and linearly elongated, defined in the inner surface of the sleeve at intervals and having a number, each groove having an open end facing the disc section and a length;
multiple denticle recesses having a number same as that of the grooves and longitudinally defined in the inner surface of the sleeve beside the grooves, each denticle recess defined between two adjacent grooves and having
an open end defined on a horizontal level where the ends of the grooves are;
a length smaller than that of each groove; and
a bottom;
multiple ramps respectively defined on the bottoms of the denticle recesses;
a first disc slidably mounted in the sleeve and having
a top;
a bottom;
an outer surface;
an inner surface;
a rod axially protruding from the top of the first disc and protruding out of the button hole;
a spring recess axially defined in the bottom of the first disc;
multiple denticles radially protruding from the outer surface of the first disc and respectively inserted slidably into the grooves; and
multiple ratchets formed inwardly on the inner surface of the first disc, each having two inclines and a tip facing the disc section; and
multiple ratchet recesses formed in the inner surface of the first disc at intervals, each defined between two adjacent ratchets of the first disc and having a bottom;
a second disc slidably mounted in the sleeve between the first disc and the pillar and abutting the top of the pillar and having
a top;
an outer surface;
multiple denticles radially protruding from the outer surface of the second disc and respectively inserted slidably into the grooves; and
multiple ratchets protruding from the top of the second disc toward the ratchets of the first disc, each ratchet having a tip abutting the incline of a corresponding ratchet of the first disc; and
a disc spring compressibly mounted between and abutting the first disc and the second disc and having an end held in the spring recess; and
the button is securely mounted around the rod.

6. The nozzle assembly as claimed in claim 3, wherein
the switch assembly further has
a sleeve mounted in the chamber and having
a bottom end;
an inner surface;
a sleeve hole axially defined through the sleeve and aligning with the button hole and the pillar hole;
multiple grooves longitudinally and linearly elongated, defined in the inner surface of the sleeve at intervals and having a number, each groove having an open end facing the disc section and a length;
multiple denticle recesses having a number same as that of the grooves and longitudinally defined in the inner surface of the sleeve beside the grooves, each denticle recess defined between two adjacent grooves and having
an open end defined on a horizontal level where the ends of the grooves are;
a length smaller than that of each groove; and
a bottom;
multiple ramps respectively defined on the bottoms of the denticle recesses;
a first disc slidably mounted in the sleeve and having
a top;
a bottom;
an outer surface;
an inner surface;
a rod axially protruding from the top of the first disc and protruding out of the button hole;
a spring recess axially defined in the bottom of the first disc;
multiple denticles radially protruding from the outer surface of the first disc and respectively inserted slidably into the grooves; and
multiple ratchets formed inwardly on the inner surface of the first disc, each having two inclines and a tip facing the disc section; and
multiple ratchet recesses formed in the inner surface of the first disc at intervals, each defined between two adjacent ratchets of the first disc and having a bottom;
a second disc slidably mounted in the sleeve between the first disc and the pillar and abutting the top of the pillar and having
a top;
an outer surface;
multiple denticles radially protruding from the outer surface of the second disc and respectively inserted slidably into the grooves; and
multiple ratchets protruding from the top of the second disc toward the ratchets of the first disc, each ratchet having a tip abutting the incline of a corresponding ratchet of the first disc; and
a disc spring compressibly mounted between and abutting the first disc and the second disc and having an end held in the spring recess; and
the button is securely mounted around the rod.
